(19) United States
(12) Patent Application Publication
(10) Pub. No.: US 2003/0118007 A1
(43) Pub. Date: Jun. 26, 2003

(54) Method and system for establishing voice communications using a computer network and a telecommunications switch

(76) Inventors: Steven Mark Williams, Boca Raton, FL (US); Greg A. Kostin, Ann Arbor, MI (US); Joseph Morita, Ann Arbor, MI (US)

Correspondence Address: Robert M. Downey, ROBERT M. DOWNEY, P.A., 150 E. Palmetto Park Road, Suite 350, Boca Raton, FL, 33432, US

(21) Appl. No.: 10/205,185

(22) Filed: Jul. 25, 2002

Related U.S. Application Data
(63) Continuation-in-part of application No. 09/655,484, filed on Sep. 5, 2000, now abandoned.

(51) Int. Cl. H04L 12/28; H04L 12/66

(52) U.S. Cl. 370/352; 370/400

(57) ABSTRACT

A caller, using a data communications enabled telephone device, establishes a data connection with a computer network and initiates data communications with a server database telephone switch, whereby the caller submits a caller identification code and a call recipient's telephone number. After the caller disconnects from the computer network, the server database telephone switch initiates a voice communications connection with the caller's telephone device over a telephone network by dialing the telephone number of the caller's telephone device which is associated with the caller identification code. Next, the server database telephone switch initiates a voice communications connection with the call recipient's telephone device over the telephone network by dialing the call recipient's telephone number. When the call recipient answers the call, voice communications are established between the caller's telephone device and the call recipient's telephone device over the telephone network.

This application is a continuation application of co-pending patent application Ser. No. 09/655,484, filed on Sep. 5, 2000.

### BACKGROUND OF THE INVENTION

1. Field of the Invention

This invention relates generally to the field of telecommunications, and more particularly, to a method and system for establishing voice communications between a data communications enabled telephone device (e.g., WAP enabled mobile phone device using GSM, PCS or Cellular) and any type of telephone device (e.g., POTS line, mobile phone, fax, modem, or any other such device).

2. Discussion of the Related Art

The use of mobile telephone devices has increased significantly over the past decade. It is projected that in the near future, more than 50 percent of telephone calls placed in the United States will originate from a mobile telephone device. And, while the cost of mobile telephone service has decreased substantially in recent years, the cost of placing overseas calls using a mobile telephone device is still considerably more expensive than overseas calls which originate from a traditional landline phone.

The present invention seeks to resolve the problem of higher costs of calls originating from a mobile phone device, as compared to a landline phone. In particular, the present invention incorporates the use of a callback system consisting of a loose integration of a web server, database and a telecommunications switch. In accordance with what is believed to be a best mode of the invention at the time of filing an application for patent for the present invention, a WAP (Wireless Application Protocol) enabled mobile telephone device is used as the data communications enable telephone device. A caller, using a WAP enabled mobile phone, originates a call by establishing a data connection with web server on the computer network (e.g., the Internet) using the phone's WML (Wireless Markup Language) micro browser. The caller is prompted, via a WML form, to enter a previously assigned access code and a destination telephone number of the call recipient. Upon submitting the form, the web server transmits the access number and destination number over the computer network to the TCP/IP enabled telecommunications switch and the caller disconnects from the computer network. The switch cross-references the access code with the telephone number of the caller's WAP enabled mobile phone and initiates a call back to the caller. Once the caller answers the call, the switch dials the destination telephone number to complete the voice connection between the caller and the call recipient.

Recently, others have proposed voice communications systems, which contemplate the use of a callback feature. In particular, U.S. Pat. No. 5,991,394 to Dezonno, et al., addresses a method and system for establishing voice communications between a computer user and an agent of a business over a computer network. This particular system is intended to assist computer users shopping for products or services on a computer network, such as the Internet. According to the method and system of Dezonno, et al., if a computer user, viewing advertisements of a business's products or services on the Internet, wishes to order a product or ask questions about a product, the computer user activates a “call me” button. A return call screen is then presented to the user, prompting the computer user to insert a name, a telephone number, and a time that an agent should call the computer user. This information is packaged in a call request that is transmitted over the Internet to a telephone switching system associated with the business. The telephone switching system subsequently dials the telephone number of the computer user at the requested time to call. When the computer user answers the telephone, the telephone switching system connects the user with the agent of the business.

U.S. Pat. No. 6,009,330 to Kennedy, III, et al. discloses a method and apparatus for delivering a call to a mobile unit on a vehicle. The call delivery system includes both a data communications network and a mobile voice communications network. According to Kennedy, III, et al., the mobile unit generates call delivery information and communicates this information to a platform using the data communications network. Upon receiving a call, the platform retrieves call delivery information received from the mobile unit and establishes communications between the platform and the mobile unit, using the mobile voice communications network. The platform then completes the call between the caller and the mobile unit. In the alternative embodiment, the platform can generate a callback message for transmission to the mobile unit using the data communications network.

Despite recent advancements in the field of telecommunications, including those which contemplate the use of a callback feature as described above, there still remains a need for a method and system to establish voice communications between a data communications enabled telephone device and any type of telephone device. A caller, using a data communications enabled telephone device, initiates a call back and subsequent connection to a destination number of a call recipient using the data communications network. The net result is a voice communication connection between the caller and call recipient as if the caller originated the call by dialing the destination number directly over the voice communication network.

### SUMMARY OF THE INVENTION

The present invention seeks to overcome many of the disadvantages and problems associated with originating a telephone call using a mobile telephone device. Accordingly, the present invention provides a system and method for establishing voice communications between a wireless telephone device and any type of telephone device. More particularly, the system and method of the present invention establishes voice communications between a caller's computer telephone and a call recipient's telephone over a telephone network indirectly via data communications between a caller's computer telephone and a server database telephone switch over a computer network.

In accordance with a preferred embodiment of the present invention, a WAP node provides callback service for users of WAP enabled mobile telephone devices. The WAP node consists of a loose integration of a web server on the Internet and a telecommunications switch. According to the preferred embodiment, in what is believed to be a best mode at the time of filing an application for patent for the present invention, the method and system establishes voice communications between a WAP enabled mobile telephone device (e.g., GSM, PCS, or Cellular) and any type of telephone device used by a call recipient (e.g., POTS line, mobile phone, fax, modem or the like) via a telecommunications switch using TCP/IP signaling over a computer network, such as the Internet. In order to use the system, a caller must first establish a callback account and be assigned a unique access code. The caller can then place a call using a WAP enabled mobile telephone device. With the use of the WAP enabled mobile telephone device, the caller navigates the Internet, via a micro browser of the mobile telephone device, to reach the URL (Uniform Resource Locator) of the WAP node. This establishes a connection with a web server on the Internet. The caller is then prompted, via a WML (Wireless Markup Language) form, to enter the caller's access code and a destination telephone number of the call recipient. Upon submitting the form, by depressing a button or clicking an icon on the WAP enabled mobile telephone device, the server transmits the access number and destination number over the computer network to the telecommunications switch which is configured to accept TCP/IP signaling. If there are no errors, the caller is instructed to terminate (i.e., disconnect) their Internet session and await a callback connection. Otherwise, if there is an error, a message is displayed. Upon receipt of the data from the WML form, the switch cross references the access code with the telephone number of the caller's mobile telephone device and initiates a callback to the caller. Once the caller answers the call, the switch dials the destination telephone number to complete the voice connection between the caller and the call recipient. From the perspective of the caller and the call recipient, the end result is as if the caller dialed the destination number direct.

### BRIEF DESCRIPTION OF THE DRAWINGS

For a fuller understanding of the nature of the present invention, reference should be made to the following detailed description taken in conjunction with the accompanying drawings, wherein:

FIG. 1 is a component diagram illustrating the system configuration and operation for establishing voice communications in accordance with the present invention;

FIG. 2 is a flow diagram illustrating the method for establishing voice communications in accordance with the present invention.

Like reference numerals refer to like parts throughout the several views of the drawings.

### DETAILED DESCRIPTION OF THE PREFERRED EMBODIMENT

According to the present invention, a method and system establishes voice communications between a caller's computer telephone 20 and a call recipient's telephone 30 over a telephone network 60 indirectly via data communications between the caller's computer telephone 20 and a server database telephone switch 40 over a computer network 50.

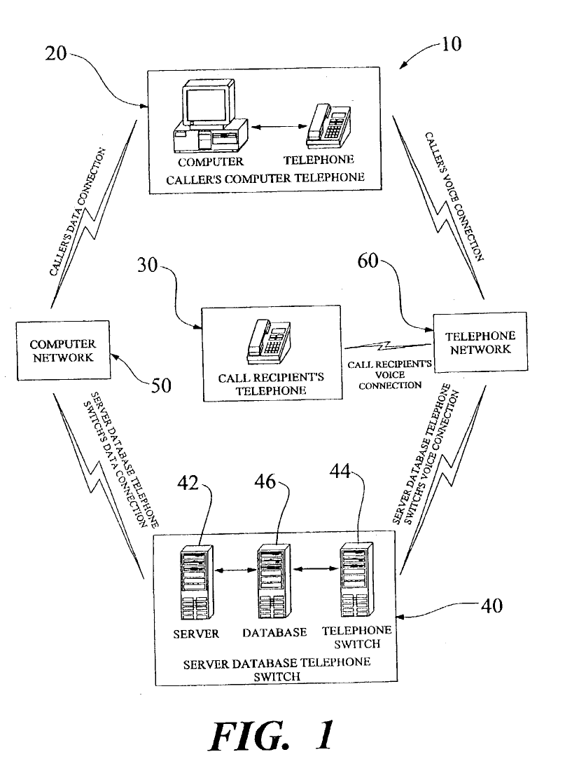

Referring to FIG. 1, a component diagram of the system 10 for establishing voice communications shows a configuration of components in accordance with a preferred embodiment of the present invention. The caller's computer telephone 20, in the preferred embodiment, is a WAP (Wireless Application Protocol) enabled mobile telephone device. Decoupling the telephone device 20 into a computer 22 and a telephone 24 would not depart from the scope of the invention. The server database telephone switch 40, in the preferred embodiment, is actually a web server 42 and a telecommunications switch 44 using TCP/IP signaling that is also hosting the database 46. As is implied by the preferred embodiment, the decoupling of the server database telephone switch 40 into separate components or any finite combination is contemplated and would not depart from the scope of the invention. The computer network 50 is the Internet or the equivalent. The telephone network 60 is the existing telephone network infrastructure which is presently used by telecommunications service provides to route calls. Finally, the call recipient's telephone 30 can be any telephone device connected to the telephone network 60.

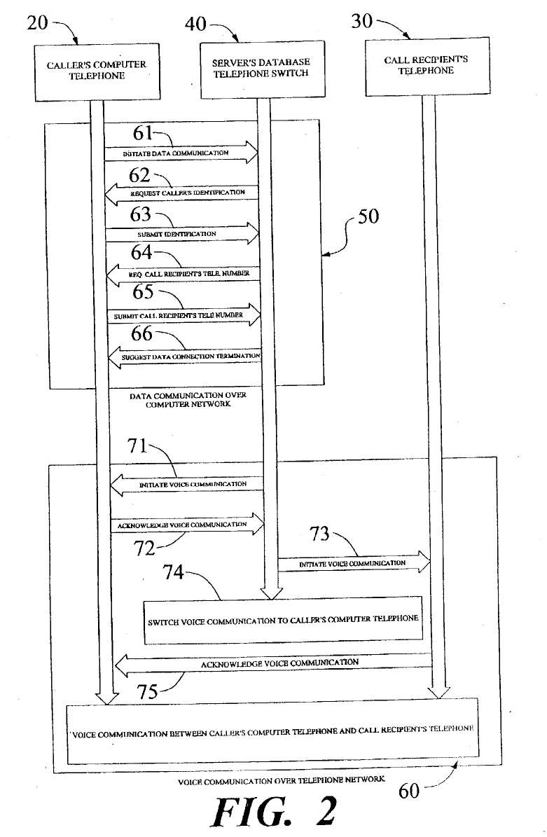

Referring to FIG. 2, a flow diagram illustrates the method for establishing voice communications in accordance with the preferred embodiment of the present invention. In the preferred embodiment, data communication over the computer network 50 is accomplished using WML (Wireless Markup Language) over the HTTP (Hypertext Transfer Protocol) on top of TCP/IP signaling. Variations in data communication are possible and all are fully contemplated within the scope of the invention. The minimum amount of data flow between the caller's computer telephone device 20 and the server database telephone switch 40 is explicitly represented. In the preferred embodiment, there is a password associated with the caller's identification sequence for added security as well as to allow for further expansion of options for the customer's ease of use (e.g., a phone directory). The additional data flow does not depart from the scope of the invention and was omitted for clarity.

In the preferred embodiment, voice communication over the telephone network 60 is accomplished using existing telephone standards. The minimum amount of voice flow between the caller's computer telephone device 20 the server database telephone switch 40 and call recipient's telephone 30 is explicitly represented. In the preferred embodiment, the voice flow is as stated in the diagram. As with the data flow, additional voice flow is fully contemplated within the scope of the invention.

To originate voice communications between the caller's computer telephone device 20 and a call recipient's telephone 30 over the telephone network 60, a caller, using the caller's computer telephone device 20, establishes a data connection with the computer network 50. In the preferred embodiment, the caller establishes the data connection by logging on and connecting to the Internet.

The caller then initiates data communications 61 with the server database telephone switch 40 which is permanently connected to the computer network 50. In the preferred embodiment, the caller enters the URL (Universal Resource Locator) of the web server via the phone device's 20 WML (Wireless Markup Language) micro browser. The server database telephone switch 40 responds with a request for caller's identification 62. In the preferred embodiment, the web server responds with a WML form request for the caller's access code. The caller responds by submitting the caller's identification 63 (or alternatively the caller's computer telephone 20 automatically submits the caller's identification 63). In the preferred embodiment, the caller enters their unique access code and submits the form. The server database telephone switch 40 responds with a request for the call recipient's telephone number 64 of the call recipient's telephone 30. In the preferred embodiment, the web server responds with a WML form request for the call recipient's telephone number. The caller responds by submitting the call recipient's telephone number 65. In the preferred embodiment, the caller enters the call recipient's phone number code and submits the form.

The server database telephone switch 40 responds with a suggestion for data connection termination 66 in preparation for a voice communications connection (Note: Depending on the capabilities of the caller's computer telephone 20, simultaneous data and voice connections may NOT be supported). In the preferred embodiment, the web server responds with a WML page requesting the caller to disconnect the telephone device 20 from the Internet 50 and await a callback.

Next, the server database telephone switch 40 initiates a voice communications connection 71 between the caller's computer telephone 20 and the server database telephone switch 40 over the telephone network 60 by dialing the phone number (associated with the caller's identification) of the caller's computer telephone device 20. The caller acknowledges 72 the voice communications connection by answering the computer telephone device 20. Upon established voice communications, the server database telephone switch 40 initiates a voice communications connection 73 between the call recipient's telephone 30 and the server database telephone switch 40 over the telephone network 60 by dialing the phone number previously submitted by the caller. The server database telephone switch 40 switches over voice communications 74 to the caller's computer telephone device 20. The call recipient acknowledges 75 the voice communication connection by answering the call recipient's telephone 30. Voice communications arc thereby established between the callers computer telephone device 20 and the call recipient's telephone 30 over the telephone network 60 indirectly via data communications between a caller's computer telephone device 20 and the server database telephone switch 40 over the computer network 50.

While the present invention has been shown and described in accordance with a preferred and practical embodiment thereof, it is recognized that departures from the instant disclosure are contemplated within the spirit and scope of the present invention which, therefore, should not be limited except as set forth in the following claims as interpreted under the doctrine of equivalents.

What is claimed is:

1. A system using a computer network for establishing voice communications between a caller using a data communications enabled telephone device and a call recipient using any telephone device, said system comprising:
a server connected to said computer network;
means for connecting said data communications enabled telephone device to said computer network to establish a data communications link between said data communications enabled telephone device and said server;
means for said server to receive data from the caller via the data communications link, said data including a unique access code assigned to the caller and a destination telephone number of the call recipient's telephone device;
means for processing said caller data to identify the telephone number of the caller's data communications enabled telephone device;
a telecommunications switch connected to said computer network and communicating with a telephone network, said telecommunications switch comprising:
means for receiving said caller data from said server;
means operable to dial the telephone number of the caller's data communications enabled telephone device to establish a voice connection over the telephone network; and
means for dialing the telephone number of the call recipient's telephone device to establish a voice connection between the caller's data communications enabled telephone device and the call recipient's telephone device over the telephone network.

2. The system as recited in claim 1 wherein said data communications enabled telephone device is a wireless application protocol enabled mobile telephone device.

3. The system as recited in claim 2 wherein said computer network is the Internet.

4. The system as recited in claim 1 wherein said means for said server to receive data from the caller includes a wireless markup language form.

5. A system for establishing voice communications with a call recipient's telephone device using a computer network and a telephone network, said system comprising:
a data communications enabled telephone device including means for connecting to the computer network to establish a data communications link;
a server including a database, said server being connected to the computer network;
said data communications enabled telephone device being structured and disposed to send and receive data to and from said server via said data communications link;
means for prompting input of caller specific data for receipt by said server, said caller specific data including a unique access code and a destination telephone number of the call recipient's telephone device;
means for processing said caller specific data to identify the telephone number of said data communications enabled telephone device; and
a telecommunications switch connected to said computer network and structured and disposed for receiving said caller specific data, said telecommunications switch being operable to dial the telephone number of the data communications enabled telephone device to establish a voice connection between said data communications switch and the data communications enabled telephone device over the telephone network, and said telecommunications switch being further operable to dial the telephone number of the call recipient's telephone device to establish a voice connection between the data communications enabled telephone device and the call recipient's telephone device over the telephone network.

6. The system as recited in claim 5 wherein said data communications enabled telephone device is a wireless application protocol enabled mobile telephone device.

7. The system as recited in claim 6 wherein said computer network is the Internet.

8. A method for establishing voice communications between a caller's data communications enabled telephone device and a call recipient's telephone device over a telephone network, said method comprising the steps of:
first, establishing a connection between said caller's data communications enabled telephone device and a computer network;
second, initiating data communications between said caller's data communications enabled telephone device and a server connected to said computer network;
third, prompting a caller to input caller specific data using said caller's data communications enabled telephone device;
fourth, requesting the caller to input the telephone number of the call recipient's telephone device;
fifth, receiving said caller specific data and the telephone number of the call recipient's telephone device by said server;
sixth, processing said caller specific data and identifying the telephone number of said caller's data communications enabled telephone device;
seventh, transferring said caller specific data, including the telephone number of the caller's data communications enabled telephone device, to a telephone switch connected to said server;
eighth, initiating a voice communications connection between said caller's data communications enabled telephone device and said telephone switch over the telephone network by dialing the telephone number of said caller's data communications enabled telephone device;
ninth, waiting for the caller lo answer the call to said caller's data communications enabled telephone device to establish voice communications between said telephone switch and said caller's data communications enabled telephone device over the telephone network;
tenth, subsequently initiating a voice communications connection between the call recipient's telephone device and said telephone switch over the telephone network by dialing the telephone number of the call recipient's telephone device previously submitted by the caller; and
eleventh, establishing a voice communications connection between said caller's data communications enabled telephone device and the call recipient's telephone device over the telephone network upon the call recipient answering the call to the call recipient's telephone device.
